(19) United States
(12) Patent Application Publication
(10) Pub. No.: US 2021/0213458 A1
(43) Pub. Date: Jul. 15, 2021

(54) PULVERIZER SYSTEM AND MILLSIDE CONFIGURATION FOR A PULVERIZER SYSTEM

(71) Applicant: GENERAL ELECTRIC COMPANY, Schenectady, NY (US)

(72) Inventors: JOHN GIULIANO, NORTH GRANBY, CT (US); ROBERT S. PRAIRIE, VERNON, CT (US)

(73) Assignee: GENERAL ELECTRIC COMPANY, Schenectady, NY (US)

(21) Appl. No.: 16/740,777

(22) Filed: Jan. 13, 2020

(51) Int. Cl. B02C 13/282; B02C 13/14

(52) U.S. Cl. CPC B02C 13/282; B02C 13/14

(57) ABSTRACT

An enclosure for a pulverizer system includes a generally cylindrical body forming an internal cavity having a central axis, a cover positioned above the cylindrical body, and a floor positioned within the internal cavity of the cylindrical body, opposite the cover, the floor having a surface extending from a point nearest the central axis to an inner sidewall of the cylindrical body. The surface of the floor has a substantially constant radius of curvature.

### BACKGROUND

### Technical Field

Embodiments of the invention relate to pulverizer systems and, more particularly, to a millside configuration for a pulverizer system that reduces operational stresses in the millside of the pulverizer system.

### DISCUSSION OF ART

Vertical pulverizer systems are used to process raw material to be used by a variety of power generation systems. For example, conventional vertical pulverizer systems may grind coal into a fine particle. The fine coal particles created by the vertical pulverizer system may be utilized by a boiler of a steam turbine system configured to generate power. Conventional vertical pulverizers typically include grinding mechanisms positioned within a sealed chamber that may grind or crush the raw material to form the fine particles.

During the pulverizering process performed by the vertical pulverizer system, the chamber, and the components positioned within the chamber, may experience a variety of stresses. For example, pressure loads may build or grow within the chamber due to the grinding mechanism having to apply enough pressure to grind the raw material. Additionally, in some instances, the raw material may be combustible (e.g., coal). As a result, the chamber of the vertical pulverizer system may also experience explosive loads. Furthermore, the chamber will experience thermal loads and/or large swings in temperature due to starting and stopping the grinding process. Additionally, large mechanical loads may be experienced by the chamber and/or the components within the chamber because of the mechanical loads required to grind the raw material within the vertical pulverizer system.

Regulatory codes, for example, National Fire Protection Association (NFPA) codes, dictate maximum allowable stresses for all sections of the pulverizer under a combination of normal grinding loads, thermal loads, and 50 psi internal pressure. To compensate for these relatively high loads (e.g., thermal, mechanical, pressure) and to meet established criteria, chambers are often made up of a variety of distinct components formed from very thick metal. These conventional chambers are typically large in size, include a variety of connection joints (e.g., welds between components) and angular transitions between surfaces and/or components forming the chamber.

Although most conventional chambers are built to withstand the experienced stresses or loads, conventional chambers include high stress concentration areas that experience the loads more than other portions of the chamber. For example, angled transitions between portions and/or components of the conventional chambers experience greater or more concentrated stress and/or loads during operation of the vertical pulverizer system. These areas may include portions of the air inlet duct and the millside floor.

For example, FIG. 1 illustrates the configuration of an air inlet duct 12 of a prior art pulverizer system 10. As shown therein, the air inlet duct 12 has a rectangular cross-section. The corners of the duct 12, however, create high stress concentrations which require significant reinforcement at the junction of the inlet duct and the millside shell 26 in order to meet established regulatory criteria during operation. Such reinforcement may be in the form of layers (i.e., added patches of material) around the border of the inlet duct (e.g., at areas 14). Such reinforcement may also be in the form of webs of material on the inside of the inlet duct 12, at the inside corners, which connect the sides 16 of the duct 12. The need for thicker material or corner reinforcements, however, can add significant material and labor costs to the manufacturing process.

FIG. 2 illustrates the configuration of the millside floor 20 of the prior art pulverizer system 10. As is common in the industry, the floor 20 has a torispherical geometry, having a spherical portion 22 having a fixed radius, and a toroidal-shaped knuckle 24 forming a transition portion between the spherical portion 22 and the cylindrical sidewall 26 of the chamber. Such a torispherical floor, while providing for satisfactory pressure containment, is difficult to manufacture and may include a high stress concentration area, A, where the floor 20 connects to the chamber sidewall/shell 26. FIG. 3 is a finite element analysis illustrating the relative thermal stress at the torispherical head/millside shell junction (area A of FIG. 2), where higher stresses are indicated by darker shaded areas.

In view of the above, there is a need for a pulverizer system having an air inlet duct geometry and millside floor geometry that meet established regulatory criteria and minimize the need for thicker materials and reinforcements in areas that typically experience high stress concentrations.

### BRIEF DESCRIPTION

In an embodiment, an enclosure for a pulverizer system is provided. The enclosure includes a generally cylindrical body forming an internal cavity having a central axis, a cover positioned above the cylindrical body, and a floor positioned within the internal cavity of the cylindrical body, opposite the cover, the floor having a surface extending from a point nearest the central axis to an inner sidewall of the cylindrical body. The surface of the floor has a substantially constant radius of curvature.

In another embodiment, an enclosure for a pulverizer system is provided. The enclosure includes a generally cylindrical body forming an internal cavity having a central axis, a cover positioned above the cylindrical body, a floor positioned within the internal cavity of the cylindrical body, opposite the cover, a gas inlet opening formed through the cylindrical body, the gas inlet opening positioned above the floor, and an inlet duct substantially surrounding the gas inlet opening, the inlet duct having curved ends and being devoid of sharp corners.

In yet another embodiment, a pulverizer system is provided. The pulverizer system includes an enclosure having a generally cylindrical body forming an internal cavity having a central axis, a cover positioned above the cylindrical body, a floor positioned within the internal cavity of the cylindrical body, opposite the cover, the floor having a surface extending from a point nearest the central axis to an inner sidewall of the cylindrical body, the floor having a substantially constant radius of curvature, a gas inlet opening formed through the cylindrical body, the gas inlet opening positioned above the floor, and an inlet duct substantially surrounding the gas inlet opening, the inlet duct being oblong in cross-section.

### DRAWINGS

The present invention will be better understood from reading the following description of non-limiting embodiments, with reference to the attached drawings, wherein below:

FIG. 1 is a perspective view of a prior art pulverizer system, illustrating a conventional rectangular air inlet duct.

FIG. 2 is a cross-sectional view of the prior art pulverizer system of FIG. 1, illustrating a conventional torispherical floor.

FIG. 3 is a finite element analysis illustrating the relative thermal stress at the torispherical floor/millside shell junction.

FIG. 4 is a perspective view of an enclosure for a vertical pulverizer system according to an embodiment of the invention.

FIG. 5 is a cross-sectional, perspective view of the enclosure for the vertical pulverizer system of FIG. 4.

FIG. 6 is an enlarged, perspective view of a portion of the vertical pulverizer system of FIG. 4, illustrating a gas inlet duct thereof.

FIG. 7 is a is an cross-sectional view of a portion of the vertical pulverizer system of FIG. 4, illustrating a floor thereof.

FIG. 8 is an enlarged, cross-sectional view of a portion of the vertical pulverizer system of FIG. 4, illustrating the configuration of the floor and the intersection between the floor and a sidewall of an enclosure of the pulverizer system.

FIG. 9 is a finite element analysis illustrating the relative stress experienced by the gas inlet duct of FIG. 6.

FIG. 10 is a finite element analysis illustrating the relative stress at the spherical disk floor/millside shell junction.

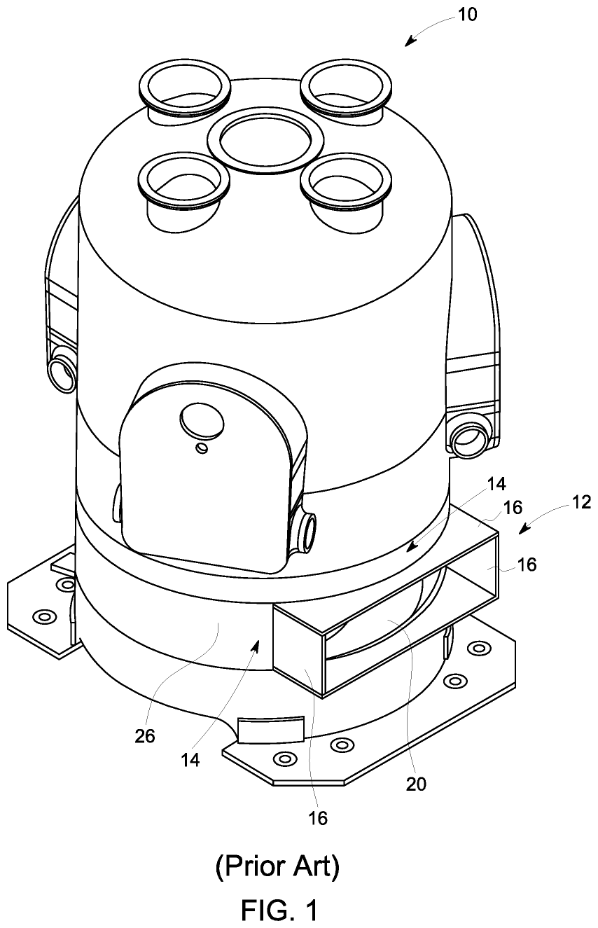

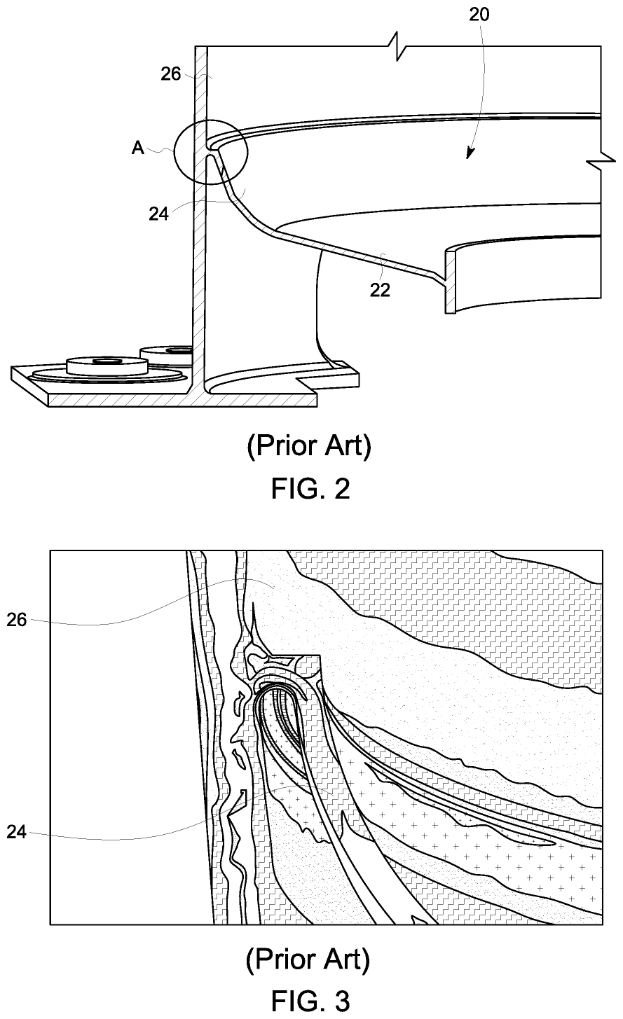

### DETAILED DESCRIPTION

Reference will be made below in detail to exemplary embodiments of the invention, examples of which are illustrated in the accompanying drawings. Wherever possible, the same reference characters used throughout the drawings refer to the same or like parts. The following disclosure relates generally to pulverizer systems, and more particularly to enclosures for vertical pulverizer systems. As used herein, “millside” refers to the section of the pulverizer shell between the elevation of the grinding surface and the foundation. As used herein, “fluidly coupled” or “fluid communication” refers to an arrangement of two or more features such that the features are connected in such a way as to permit the flow of fluid between the features and permits fluid transfer.

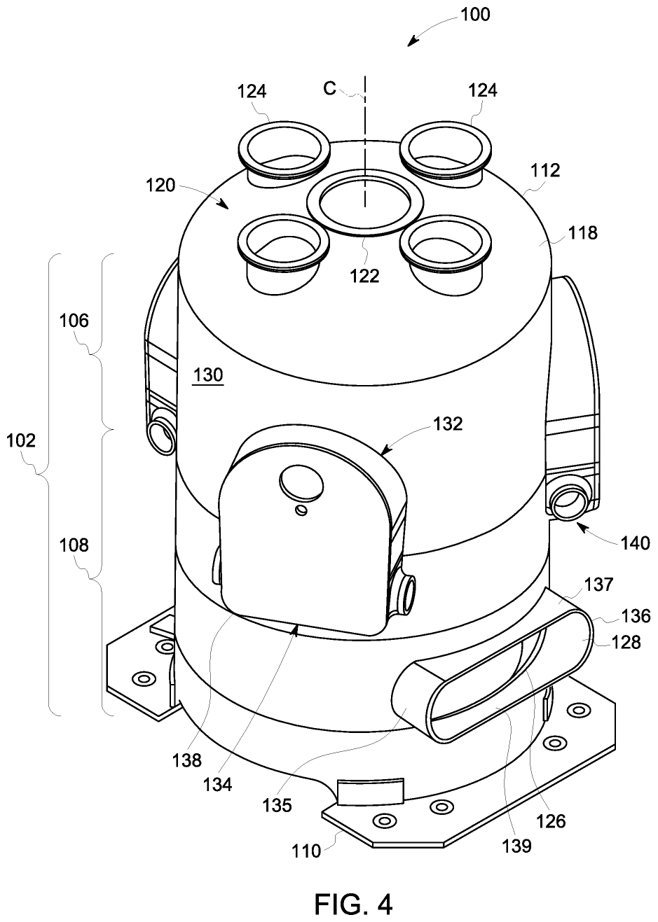

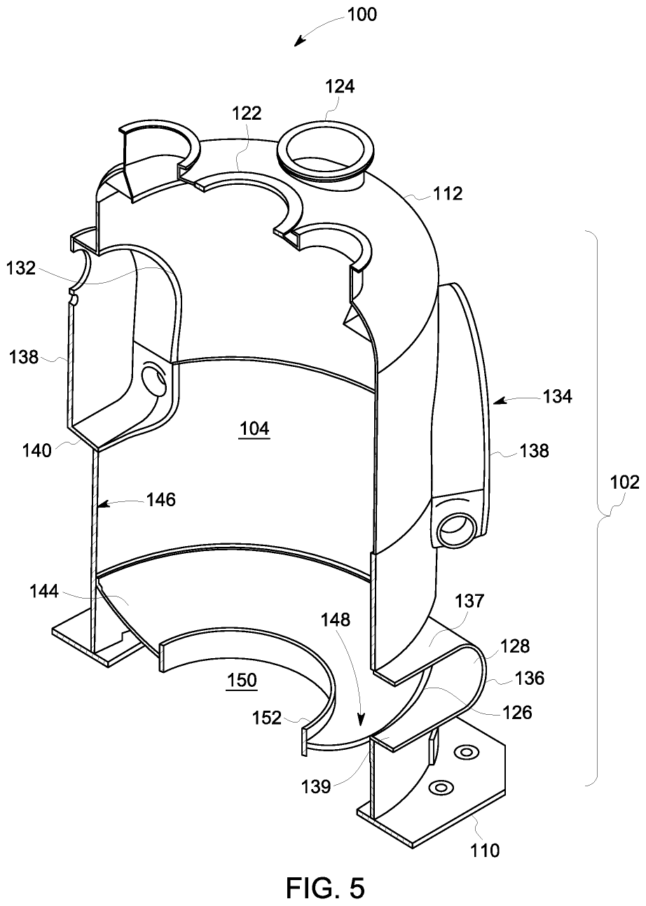

FIGS. 4 and 5 show various distinct views of a housing or enclosure 100 for a vertical pulverizer system according to an embodiment of the invention. The housing or enclosure 100 may be referred to herein as “pulverizer system” even through the gearbox, grinding wheels and other internal components are omitted from the figures. As shown therein, enclosure 100 includes a cylindrical body 102. Cylindrical body 102 may be vertically oriented and may include substantially linear walls. As shown and discussed herein, cylindrical body 102 may form an internal cavity 104 (see FIG. 5) for enclosure 100 and may substantially house and/or surround various components of enclosure 100 and/or the vertical pulverizer system. In a non-limiting example shown in FIGS. 4 and 5, cylindrical body 102 may include at least two distinct portions. Specifically, cylindrical body 102 may include an upper portion 106 and a lower or bowl portion 108 positioned below and/or coupled to upper portion 106. Although two portions are shown, it is understood that cylindrical body 102 may be formed from more distinct portions. In another non-limiting example, cylindrical body 102 may be formed from a single component or piece of material. Cylindrical body 102 of enclosure 100 may be formed from any material that may withstand pressure changes, excursions, mechanical stresses and/or temperature variations that may be experienced during the operation of the vertical pulverizer system, as discussed herein. In non-limiting examples, cylindrical body 102, and specifically upper portion 106 and bowl portion 108, may be formed from metal and/or metal alloys. Additionally cylindrical body 102 of enclosure 100 may be formed using any suitable material forming process or technique including, but not limited to, rolling, casting, forming and/or similar processes.

As further shown in FIGS. 4 and 5, enclosure 100 may also include a plurality of feet 110. Feet 110 may be positioned below cylindrical body 102 and may extend perpendicular to cylindrical body 102. In a non-limiting example shown in FIGS. 4 and 5, feet 110 may be a distinct component from cylindrical body 102 and may be coupled to the bottom of bowl portion 108 of cylindrical body 102. In another non-limiting example, feet 110 may be formed integrally with cylindrical body 102, and may be formed and/or shaped to extend perpendicular to cylindrical body 102. As discussed herein, feet 110 may be coupled to a support of a vertical pulverizer system utilizing enclosure 100 to support enclosure 100 and the various components of the system positioned within enclosure 100.

Enclosure 100 may also include a cover 112 positioned above cylindrical body 102. The cover 112 may be coupled to cylindrical body 102, and specifically, upper portion 106 of cylindrical body 102. Cover 112 may be coupled to cylindrical body 102 to substantially close and/or form a closed end for internal cavity 104 (see FIG. 5) formed by cylindrical body 102 of enclosure 100. Cover 112 may be coupled to cylindrical body 102 using any suitable coupling mechanisms and/or coupling techniques. For example, cover 112 may be coupled to cylindrical body 102 using mechanical fasteners, such as bolts, or alternatively, cover 112 may be welded to cylindrical body 102. Similar to cylindrical body 102, cover 112 may be formed from any material that may withstand pressure changes, excursions, mechanical stresses and/or temperature variations that may be experienced during the operation of the vertical pulverizer system, as discussed herein. In non-limiting examples, cover 112 may be formed from metal and/or metal alloys. Additionally, cover 112, and the various components or portions of cover 112 discussed herein, may be formed using any suitable material forming process or technique including, but not limited to, rolling, casting, forming and/or similar processes.

As best shown in FIG. 5, cover 112 may include a substantially curved, non-linear and/or dome-shaped surface 118. In the non-limiting example shown in FIG. 5, curved surface 118 of cover 112 may be substantially convex with respect to internal cavity 104 of cylindrical body 102. Specifically, cover 112 may include an inner curved surface (not shown) facing and/or positioned within internal cavity 104 that may be substantially convex in shape. Curved surface 118 of cover 112 may include any non-linear geometry and/or shape including, but not limited to, torispherical, hemispherical, ellipsoidal and any other dome-shaped geometry. The curved surface 118 of cover 112 may extend completely, fully or substantially around the perimeter and/or entirety of cover 112.

Various channels may be formed through cover 112 of enclosure 100. That is, cover 112 may include various channels formed through a top portion 120 of cover 112. As shown in FIGS. 4 and 5, a material inlet channel 122 may be formed through top portion 120 of cover 112. In a non-limiting example, material inlet channel 122 may be formed completely through a center (C) of cover 112, which also is a central axis of the body 102. Additionally, material inlet channel 122 may extend away from and/or above a surface of cover 112. Material inlet channel 122 formed in cover 112 may be in fluid communication with internal cavity 104 formed by cylindrical body 102. As discussed herein, material inlet channel 122 may be configured and/or utilized within the vertical pulverizer system to provide raw material (e.g., coal) to components of the vertical pulverizer system to be processed within enclosure 100. Additionally, although shown in FIGS. 4 and 5 as being formed through center (C) of cover 112, it is understood that material inlet channel 122 may be formed through any portion of cover 112 to be in fluid communication with and/or provide raw material to enclosure 100.

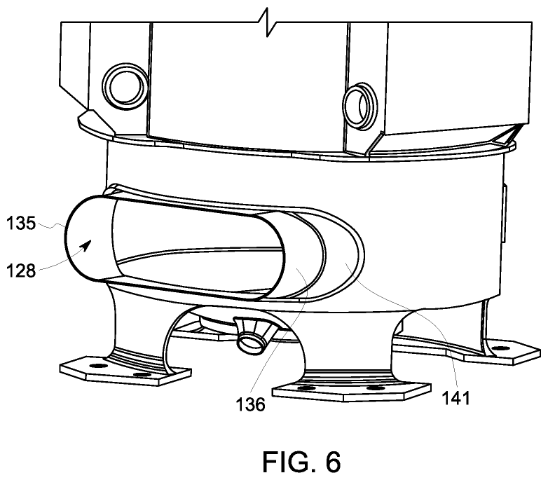

Cover 112 may also include at least one particle outlet channel 124. The particle outlet channel 124 may be formed completely through cover 112, such that particle outlet channel 124 may also be in fluid communication with internal cavity 104 formed by cylindrical body 102. Particle outlet channel 124 may be formed through top portion 120 of cover 112 adjacent material inlet channel 122. Similar to material inlet channel 122, particle outlet channel 124 may extend away from and/or above a surface of cover 112. In a non-limiting example\\, cover 112 of enclosure 100 may include four (4) distinct particle outlet channels 124 formed therein. Particle outlet channels 124 may substantially surround and may be spaced approximately equidistant apart from material inlet channel 122 and each other, respectively. Although four particle outlet channels 124 are depicted in FIGS. 4 and 6, it is understood that the number of particle outlet channels 124 shown in the figures is merely illustrative and cover 112 may include more or less particle outlet channels 124 than the number depicted and discussed herein. Particle outlet channels 124 may be configured and/or utilized within the vertical pulverizer system to allow and/or carry processed particles of the raw material (e.g., coal) away from enclosure 100 and to a distinct power system that may utilize the vertical pulverizer system.

As best shown in FIGS. 4 and 6, enclosure 100 may also include a gas inlet opening 126. Gas inlet opening 126 may be formed through cylindrical body 102. Specifically, gas inlet opening 126 may be formed through bowl portion 108 of cylindrical body 102. Gas inlet opening 126 may provide access and/or fluid communication between internal cavity 104 (see FIG. 5) formed by cylindrical body 102 and an air system of the vertical pulverizer system, as discussed herein. An inlet cover or duct 128 may substantially surround gas inlet opening 126 formed through cylindrical body 102. As shown, inlet duct 128 may be positioned on and/or coupled to an exposed or outer surface 130 of cylindrical body 102 and may extend or protrude away from cylindrical body 102. As discussed herein, inlet duct 128 may couple a gas system of the vertical pulverizer system to enclosure 100, such that the gas system may provide gas (e.g., air) within enclosure 100 via gas inlet opening 126.

As best illustrated in FIGS. 4 and 6, the air inlet duct 128 is substantially obround or stadium-shaped in cross-section, having two opposed, semi-circular/semi-cylindrical ends 135, 136 and linear/planar top and bottom sides 137, 139 connecting the tangent points of the ends 135, 136. In an embodiment, the air inlet duct 128 is oriented substantially horizontally. It is contemplated, however, that in some embodiments, the air inlet duct may be round/circular in cross-section. In yet other embodiments, the air inlet duct 128 may have arcuate or curved ends, and substantially linear/planar sides connected the opposed ends and, in any implementation, is devoid of sharp corners. In an embodiment, the opening 126 may have a shape that generally corresponds to the cross-sectional shape of the air inlet duct 128. As best shown in FIG. 6, in certain embodiments, the enclosure 100 may include a single layer 141 of reinforcement around the border of the inlet duct 128, at the junction of the inlet duct 138 and the cylindrical body/millside shell 102. In an embodiment, no layers of reinforcement are necessary.

This air inlet duct configuration eliminates the corners and reinforcements that standard inlet ducts have, which have typically been necessary to comply with regulatory codes. In particular, the use of rounded ends in place of sharp corners reduces the stress concentrations. This particular configuration is also more robust, is lower in cost (material and labor) to manufacture than conventional rectangular inlet ducts.

Referring further to FIGS. 4 and 5, enclosure 100 may also include a journal opening 132 and a journal opening cover 134 substantially covering journal opening 132. Journal opening 132 and journal opening cover 134 may provide an opening a cover and/or support structure for a journal of the vertical pulverizer system that may be used to process raw material within enclosure 100 during operation of the vertical pulverizer system. The journal opening 132 may be formed through cylindrical body 102, below cover 112. In a non-limiting example where cylindrical body 102 is formed from upper portion 106 and bowl portion 108, journal opening 132 may be formed through a portion of each of upper portion 106 and bowl portion 108. As a result, when upper portion 106 and bowl portion 108 are coupled together to form cylindrical body 102, journal opening 132 may be a single opening and/or aperture formed through cylindrical body 102.

In the non-limiting example shown in FIGS. 4 and 5, enclosure 100 may include three distinct journal openings 132 formed through cylindrical body 102. However, it is understood that the number of depicted journal openings 132 formed through cylindrical body 102 may be merely exemplary and may not be considered limiting. As discussed herein, journal opening 132 formed through cylindrical body 102 may provide access to internal cavity 104 formed by cylindrical body 102 and/or components utilized by the vertical pulverizer system that may be positioned within cylindrical body 102 and substantially through and/or within journal opening 132.

In the non-limiting example shown in FIGS. 4 and 5, journal opening 132 may include a door 138 configured to provide access to internal cavity 104 of cylindrical body 102, a trunnion support 140 positioned adjacent and below door 138 and a curved side wall 142 positioned substantially perpendicular to door 138. Door 138 may be coupled to both trunnion support 140 and curved side wall 142, respectively. In a non-limiting example, door 138 may be releasably coupled to trunnion support 140 and/or curved side wall 142. As a result, door 138 may be released, removed, hinged and/or otherwise uncoupled from trunnion support 140 and/or curved side wall 142 to provide access to internal cavity 104 and/or the components of the vertical pulverizer system that are positioned within cylindrical body 102. In other non-limiting examples discussed herein where components of the vertical pulverizer system are attached and/or coupled to door 138, door 138 may be uncoupled and/or hinged to at least partially remove the components of the vertical pulverizer system from enclosure 100. As shown in FIGS. 4 and 5, and as discussed below, door 138 may be formed to substantially match or mirror the shape and/or geometry of journal opening 132 and/or curved side wall 142.

As further shown in FIG. 5, enclosure 100 may also include base component or millside floor 144. Floor 144 may be positioned within internal cavity 104 of cylindrical component 102, opposite cover 112. Specifically, floor 144 may be positioned within bowl portion 108 of cylindrical body 102 and may be positioned below upper portion 106, cover 112 and journal opening cover 134. Additionally, floor 144 may be positioned adjacent and/or below gas inlet opening 126 formed through bowl portion 108 of cylinder body 102. As shown in FIG. 5, cylindrical body 102 extends below floor 144 and cylindrical body 102 may substantially surround floor 144, such that floor 144 may not be visible when enclosure 100 is assembled.

As illustrated in FIG. 5, the floor 144 may be coupled to an inner surface 146 of cylindrical body 102. Floor 144 may be coupled to inner surface 146 of cylindrical body 102 using any suitable coupling mechanisms and/or coupling techniques. For example, floor 144 may be coupled to cylindrical body 102 using mechanical fasteners, such as bolts, or alternatively, floor 144 may be welded to cylindrical body 102. Similar to cylindrical body 102 and/or cover 112 discussed herein, floor 144 may be formed from any material that may withstand pressure changes, excursions, mechanical stresses and/or temperature variations that may be experienced during the operation of the vertical pulverizer system, as discussed herein. In non-limiting examples, floor 144 may be formed from metal and/or metal alloys. Floor 144 may be formed using any suitable material forming process or technique including, but not limited to, rolling, casting, forming and/or similar processes.

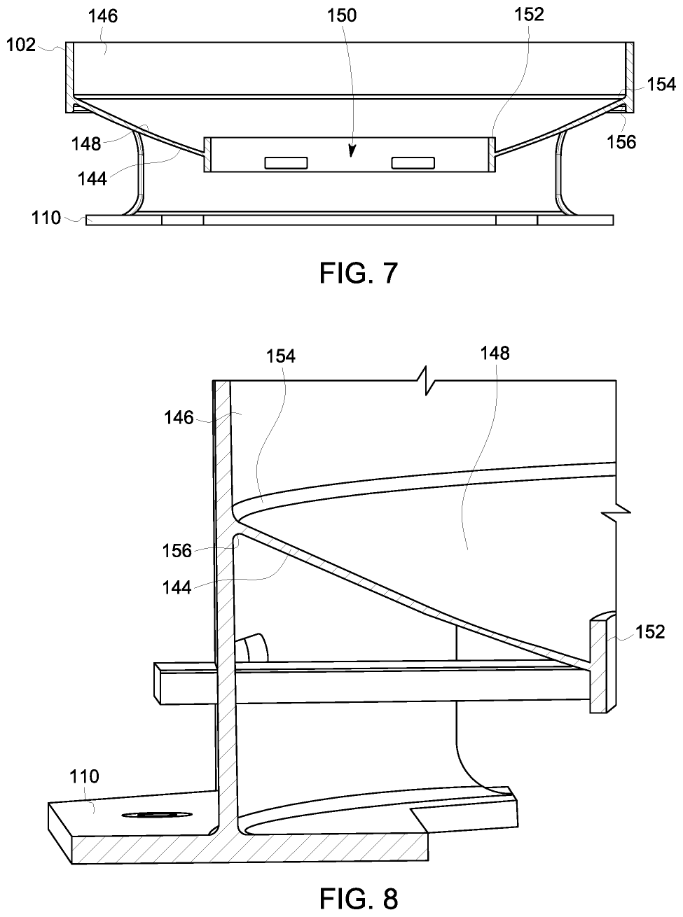

With particular reference to FIGS. 7 and 8, in contrast to existing pulverizer systems, the floor 144 of enclosure/pulverizer system 100 has a spherical or hemispherical, not torispherical, shaped surface 148, and is devoid of any knuckle or transition portion of different radius that connects the floor 144 to the inner surface/sidewall 146 of the enclosure. The spherical surface 148 of floor 144 may be substantially concave with respect to internal cavity 104 of cylindrical body 102. Similar to curved surface 118 of cover 112, the surface 148 of floor 144 may extend completely, fully or substantially around the perimeter and/or entirety of floor 144. As discussed herein, the geometry and/or shape of surface 148 of floor 144 may aid and/or improve the effects of temperature change, air flow and/or pressure containment within enclosure 100 during operation of the vertical pulverizer system that utilizes enclosure 100.

As further shown in FIG. 5, floor 144 may also include an aperture 150 formed substantially through floor 144. Aperture 150 may be formed through the center of floor 144 and may substantially receive a portion of a rotatable table of the vertical pulverizer system utilizing enclosure 100. Aperture 150 of floor 144 may be substantially aligned with a bottom seal 152. That is, bottom seal 152 may be coupled and may line aperture 150 of floor 144. As discussed herein, bottom seal 152 may prevent gas (e.g., air) provided to cylindrical body 102 via gas inlet opening 126 from leaking out of cylindrical body 102 between floor 144 and the rotatable table of the vertical pulverizer system. In another non-limiting example, bottom seal 152 may prevent raw material that is discharged and/or discarded from the rotatable table from falling out of enclosure 100 and/or into distinct portions of the vertical pulverizer system that may be damaged by the discharged and/or discarded raw material.

As indicated above, the surface 148 of the floor 144 is formed as a spherical disk (being a section of a sphere having a substantially constant radius), is not torispherical in shape, and is devoid of any knuckle or transition portion of different radius that connects the floor 144 to the inner surface/sidewall 146 of the enclosure 100. In particular, the surface 148 of floor 144 has a substantially constant radius throughout the entire extent of the surface 148, from the seal 152 to the inner surface 146 of cylindrical body 102. As best shown in FIG. 8, the intersection of the floor 144 with the inner surface/sidewall 146 of the enclosure 100 includes filleted areas (e.g. first fillet 154 and second fillet 156) which function to reduce stress concentrations at such intersection.

It has been discovered that the spherical disk floor 144 has the pressure-containment benefits of a conventional torispherical floor, but with the advantage of a simplified, lower stress, connection to the millside shell. The spherical disk floor 144 is also simpler to manufacture than a conventional torispherical floor because it is a constant radius throughout (being devoid of any knuckle radius).

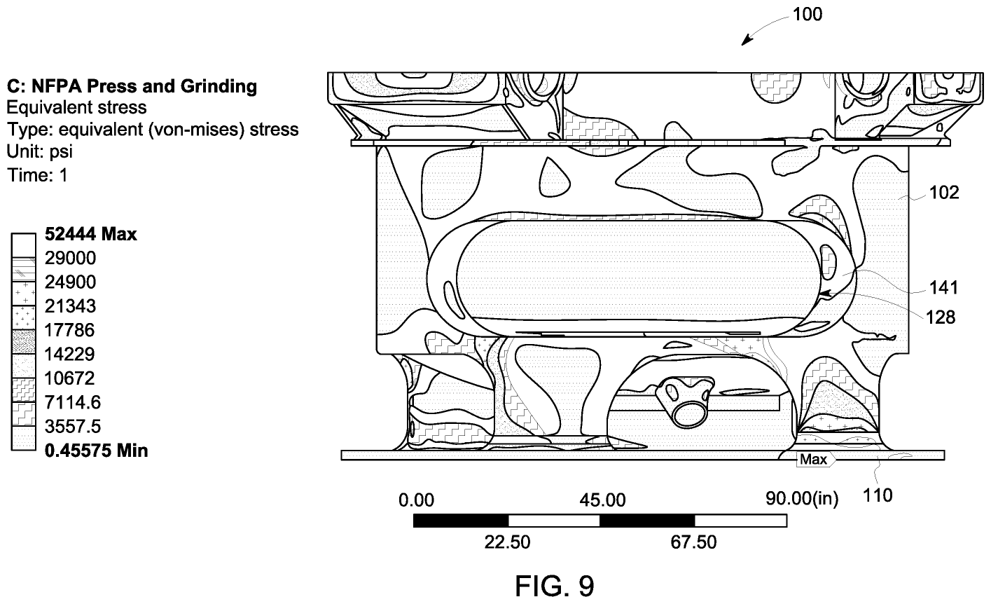

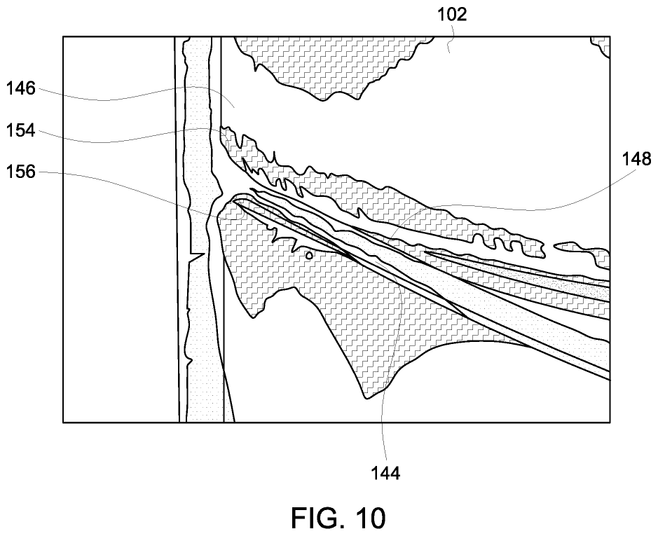

As indicated above, both the spherical disk floor 144 and the obround inlet duct 128 reduce operational stresses in the millside of the pulverizer and reduce millside manufacturing costs (both labor and material), as compared to a conventional torispherical floor and rectangular inlet duct, respectively. FIGS. 9 and 10 illustrate the results of finite element analyses of the relative thermal stresses experienced by the gas inlet duct and spherical disk floor/millside shell junction, respectively, of the invention. These analyses reveal no elevated stresses at the critical areas where prior art designs have typically seen elevated stress concentrations. As evidenced by these finite element analyses, the air inlet duct geometry and millside floor geometry of the invention meet established regulatory criteria and minimize or obviate the need for thicker materials and reinforcements in areas that typically experience high stress concentrations.

In an embodiment, the enclosure 100 disclosed herein may be part of a vertical pulverizer system such as that disclosed in U.S. Patent Application Publication No. 2018/0036739, which is hereby incorporated by reference herein in its entirety.

In an embodiment, an enclosure for a pulverizer system is provided. The enclosure includes a generally cylindrical body forming an internal cavity having a central axis, a cover positioned above the cylindrical body, and a floor positioned within the internal cavity of the cylindrical body, opposite the cover, the floor having a surface extending from a point nearest the central axis to an inner sidewall of the cylindrical body. The surface of the floor has a substantially constant radius of curvature. In an embodiment, the surface is configured as a spherical disk. In an embodiment, the surface is devoid of a knuckle having a radius that is different than the constant radius of the curvature of the surface. In an embodiment, the floor further includes an aperture formed through the floor, the aperture configured to receive a rotatable table of a pulverizer system. In an embodiment, the enclosure may further include a bottom seal coupled to and lining the aperture of the floor, wherein the surface having the constant radius of curvature extends from the bottom seal to the inner sidewall. In an embodiment, the enclosure includes a first fillet at an intersection of the floor and the inner sidewall of the cylindrical body, the first fillet being located generally above the floor. In an embodiment, the enclosure includes a second fillet at an intersection of the floor and the inner sidewall of the cylindrical body, the second fillet being located generally below the floor. In an embodiment, the enclosure includes a gas inlet opening formed through the cylindrical body, the gas inlet opening positioned above the floor and an inlet duct substantially surrounding the gas inlet opening. In an embodiment, the inlet duct has curved ends and is devoid of sharp corners. In an embodiment, inlet duct is obround in cross-section. In an embodiment, the inlet duct is circular in cross-section. In an embodiment, the enclosure further includes only a single layer of reinforcement around a border of the inlet duct.

In another embodiment, an enclosure for a pulverizer system is provided. The enclosure includes a generally cylindrical body forming an internal cavity having a central axis, a cover positioned above the cylindrical body, a floor positioned within the internal cavity of the cylindrical body, opposite the cover, a gas inlet opening formed through the cylindrical body, the gas inlet opening positioned above the floor, and an inlet duct substantially surrounding the gas inlet opening, the inlet duct having curved ends and being devoid of sharp corners. In an embodiment, inlet duct is obround in cross-section. In an embodiment, the inlet duct is circular in cross-section. In an embodiment, the enclosure includes only a single layer of reinforcement around a border of the inlet duct. In an embodiment, the floor has a surface extending from a point nearest the central axis to an inner sidewall of the cylindrical body, wherein the surface of the floor has a substantially constant radius of curvature. In an embodiment, the floor further includes an aperture formed through the floor, the aperture configured to receive a rotatable table of a pulverizer system, wherein the enclosure further includes a bottom seal coupled to and lining the aperture of the floor, and wherein the surface having the constant radius of curvature extends from the bottom seal to the inner sidewall. In an embodiment, the enclosure further includes at least one of a first fillet at an intersection of the floor and the inner sidewall of the cylindrical body, the first fillet being located generally above the floor, and/or a second fillet at the intersection of the floor and the inner sidewall of the cylindrical body, the second fillet being located generally below the floor.

In yet another embodiment, a pulverizer system is provided. The pulverizer system includes an enclosure having a generally cylindrical body forming an internal cavity having a central axis, a cover positioned above the cylindrical body, a floor positioned within the internal cavity of the cylindrical body, opposite the cover, the floor having a surface extending from a point nearest the central axis to an inner sidewall of the cylindrical body, the floor having a substantially constant radius of curvature, a gas inlet opening formed through the cylindrical body, the gas inlet opening positioned above the floor, and an inlet duct substantially surrounding the gas inlet opening, the inlet duct being oblong in cross-section. In an embodiment, the enclosure includes at least one of a first fillet at an intersection of the floor and the inner sidewall of the cylindrical body, the first fillet being located generally above the floor, and/or a second fillet at the intersection of the floor and the inner sidewall of the cylindrical body, the second fillet being located generally below the floor.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. An enclosure for a pulverizer system, comprising:
a generally cylindrical body forming an internal cavity having a central axis;
a cover positioned above the cylindrical body; and
a floor positioned within the internal cavity of the cylindrical body, opposite the cover, the floor having a surface extending from a point nearest the central axis to an inner sidewall of the cylindrical body;
wherein the surface of the floor has a substantially constant radius of curvature.

2. The enclosure of claim 1, wherein:
the surface is configured as a spherical disk.

3. The enclosure of claim 1, wherein:
the surface is devoid of a knuckle having a radius that is different than the constant radius of the curvature of the surface.

4. The enclosure of claim 1, wherein:
the floor further includes an aperture formed through the floor, the aperture configured to receive a rotatable table of a pulverizer system.

5. The enclosure of claim 4, further comprising:
a bottom seal coupled to and lining the aperture of the floor;
wherein the surface having the constant radius of curvature extends from the bottom seal to the inner sidewall.

6. The enclosure of claim 5, further comprising:
a first fillet at an intersection of the floor and the inner sidewall of the cylindrical body, the first fillet being located generally above the floor.

7. The enclosure of claim 5, further comprising:
a second fillet at an intersection of the floor and the inner sidewall of the cylindrical body, the second fillet being located generally below the floor.

8. The enclosure of claim 1, further comprising:
a gas inlet opening formed through the cylindrical body, the gas inlet opening positioned above the floor; and
a gas inlet duct substantially surrounding the gas inlet opening.

9. The enclosure of claim 8, wherein:
the gas inlet duct has curved ends and is devoid of sharp corners.

10. The enclosure of claim 8, wherein:
the gas inlet duct is obround in cross-section.

11. The enclosure of claim 8, wherein:
the gas inlet duct is circular in cross-section.

12. The enclosure of claim 9, further comprising:
only a single layer of reinforcement around a border of the gas inlet duct.

13. An enclosure for a pulverizer system, comprising:
a generally cylindrical body forming an internal cavity having a central axis;
a cover positioned above the cylindrical body;
a floor positioned within the internal cavity of the cylindrical body, opposite the cover;
a gas inlet opening formed through the cylindrical body, the gas inlet opening positioned above the floor; and
an inlet duct substantially surrounding the gas inlet opening, the inlet duct having curved ends and being devoid of sharp corners.

14. The enclosure of claim 13, wherein:
inlet duct is obround in cross-section.

15. The enclosure of claim 13, wherein:
the inlet duct is circular in cross-section.

16. The enclosure of claim 13, further comprising:
only a single layer of reinforcement around a border of the inlet duct.

17. The enclosure of claim 13, wherein:
the floor has a surface extending from a point nearest the central axis to an inner sidewall of the cylindrical body;
wherein the surface of the floor has a substantially constant radius of curvature.

18. The enclosure of claim 17, wherein:
the floor further includes an aperture formed through the floor, the aperture configured to receive a rotatable table of a pulverizer system;
wherein the enclosure further includes a bottom seal coupled to and lining the aperture of the floor; and
wherein the surface having the constant radius of curvature extends from the bottom seal to the inner sidewall.

19. The enclosure of claim 13, further comprising:
at least one of a first fillet at an intersection of the floor and the inner sidewall of the cylindrical body, the first fillet being located generally above the floor, and/or a second fillet at the intersection of the floor and the inner sidewall of the cylindrical body, the second fillet being located generally below the floor.

20. A pulverizer system, comprising:
an enclosure having:
a generally cylindrical body forming an internal cavity having a central axis;
a cover positioned above the cylindrical body;
a floor positioned within the internal cavity of the cylindrical body, opposite the cover, the floor having a surface extending from a point nearest the central axis to an inner sidewall of the cylindrical body, the floor having a substantially constant radius of curvature.
a gas inlet opening formed through the cylindrical body, the gas inlet opening positioned above the floor; and
an inlet duct substantially surrounding the gas inlet opening, the inlet duct being oblong in cross-section.

21. The pulverizer system of claim 20, wherein:
the enclosure includes at least one of a first fillet at an intersection of the floor and the inner sidewall of the cylindrical body, the first fillet being located generally above the floor, and/or a second fillet at the intersection of the floor and the inner sidewall of the cylindrical body, the second fillet being located generally below the floor.
